(19) United States
(12) Patent Application Publication
(10) Pub. No.: US 2024/0418223 A1
(43) Pub. Date: Dec. 19, 2024

(54) ISOLATED ELECTRIC COUPLER

(71) Applicant: Tesla, Inc., Austin, TX (US)

(72) Inventors: Scott Michael Graves, Felton, CA (US); Sina Mobasher Moghaddam, Palo Alto, CA (US)

(21) Appl. No.: 18/701,180

(22) PCT Filed: Nov. 29, 2022
(86) PCT No.: PCT/US2022/051279

§ 371 Date: Apr. 12, 2024

Related U.S. Application Data
(60) Provisional application No. 63/284,555, filed on Nov. 30, 2021.

(51) Int. Cl. F16D 1/08; B60K 17/04

(52) U.S. Cl. CPC F16D 1/0876; B60K 17/04; F16D 2300/08

(57) ABSTRACT

Generally described, aspects of the present application relate to mitigation of induced voltages in rotor components of an electric motor. Illustratively, one or more aspects relates to incorporation of one or more electrically insulating elements to isolate the rotor from the rest of the components of the electric motor. The electrically insulating elements are integrated into a coupler mechanism between the rotor and stator. Through insulation, the induced voltages cannot discharge through gears and bearings. Illustratively, the isolation coupler is placed on or proximate to the rotor shaft centerline and provides torque transmission.

### CROSS REFERENCE TO RELATED APPLICATION

This application claims the benefit to U.S. Provisional Application No. 63/284,555, entitled ISOLATED ELECTRIC COUPLER, and filed on Nov. 30, 2021. U.S. Provisional Application No. 63/284,555 is incorporated by reference herein in its entirety.

### BACKGROUND

Generally described, a variety of vehicles, such as electric vehicles, combustion engine vehicles, hybrid vehicles, etc., can be configured with various components to facilitate operation of the vehicle. Traditionally, many components are specifically configured in accordance with the specifications required to implement the specified functionality. For example, attributes of structural components within a vehicle (e.g., materials, dimensions, mounting, etc.) are specified and selected in a manner that meets or exceeds loads placed on the structural components.

Electric motors are widely used in a variety of industrial and residential applications. In general, this type of motor includes a laminated magnetic core mounted to a drive shaft. Electric motors typically include a rotor that a rotating component and such that rotation is due to the interaction between the windings and magnetic fields which produces a torque around the rotor's axis. The laminated magnetic core may be fabricated from a plurality of laminated magnetic discs, or from a plurality of arc-like core segments. The laminated magnetic core includes a plurality of longitudinal slots into which bars or wires of electrically conductive metal are fit. The ends of the bars extend beyond either end of the laminated magnetic core. An end-ring or end-cap at either end of the laminated magnetic core is used to mechanically and electrically join the ends of the rotor bars. As part of an electric motor, the stator is the stationary part of a rotary system that converts the rotating magnetic field to electric current.

### BRIEF DESCRIPTION OF THE DRAWING FIGURES

This disclosure is described herein with reference to drawings of certain embodiments, which are intended to illustrate, but not to limit, the present disclosure. It is to be understood that the accompanying drawings, which are incorporated in and constitute a part of this specification, are for the purpose of illustrating concepts disclosed herein and may not be to scale.

FIG. 1 is a block diagram illustrative of an embodiment of an electric vehicle for use in accordance with illustrative embodiments of the present application;

FIG. 2 illustrates a sectional view of a drive motor and a gear box configured for use in accordance with illustrative embodiments of the present application;

FIG. 3A illustrates a perspective view of an input gear with an isolated coupler formed in accordance with illustrative embodiments of the present application;

FIG. 3B is a perspective view of insulating elements for utilization in illustrative embodiments of an input gear;

FIG. 3C illustrates a a perspective view of an input gear with an isolated coupler including six insulating elements in accordance with illustrative embodiments of the present application;

FIG. 3D illustrates a perspective view of a retainer for facilitating and retention of the insulating elements 110 in an input gear;

FIG. 4 illustrates a perspective view of a portion of an electric motor including a rotor for utilization in combination with illustrative input gear; and

FIG. 5 illustrates an exploded perspective view of an alternative embodiment of an input gear and portion of a rotor.

### DETAILED DESCRIPTION

Generally described, one or more aspects of the present disclosure relate management of electrically induced damage in components of a vehicle. More specifically, aspects of the present application relate to mitigation of induced voltages in rotor components of an electric motor. Illustratively, one or more aspects relates to incorporation of one or more electrically insulating elements to isolate the rotor from the rest of the components of the electric motor. The electrically insulating elements are integrated into a coupler mechanism between the rotor and stator. Through insulation, the induced voltages cannot discharge through gears and bearings. Illustratively, the isolation coupler is placed on or proximate to the rotor shaft centerline and provides torque transmission.

Typical solutions for Electrically Induced Bearing Damage (“EIBD”) include incorporating a stable grounding solution from the rotor to a chassis ground. For example, some electric motors can include a carbon/silver brush or similar solution that attempts to function as a stable ground. These have disadvantages of high drag and limited lifetime, which can be particularly deficient in implementations of long-term use, such as semitrucks. Another solution for EIBD corresponds to use a common mode choke that functions as an electrical filter to block high frequency signals such as those generated in the operation of an electric motor. Common mode choke solutions can correspond to nanocrystalline or ferrite cores that surround the 3 phases of the motor leads to quell the common mode overshoot voltages. Typically, common mode choke solutions are expensive and difficult to package. They also have limited effectiveness as they do not fully mitigate discharges. These and other typical solutions may be further deficient in electric vehicle implementations in which the common mode voltage is scaled with input voltage.

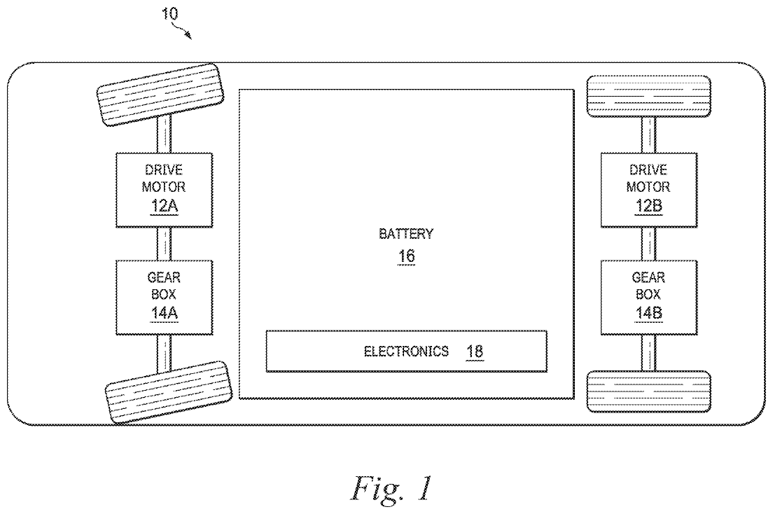

FIG. 1 illustrates an embodiment of an electric vehicle 10. The embodiment of the electric vehicle 10 comprises a battery 16, electronics 18, a first drive motor 12A, a first gear box 14A, a second drive unit 14B, and a second gear box 14B. The electronic vehicle may be controlled by electronics 18. The battery 16 may provide power to the first drive motor 12A, the second drive motor 12B, or both. The first drive motor 12A and the second drive motor 12B may be electric motors. The first drive motor 12A may be connected to the first drive unit 14A, and that connection may be an electrically isolated connection. The second drive motor 12B may be connected to the second drive unit 14A, and that connection may be an electrically isolated connection. The first drive motor 12A may be connected to the first drive unit 14A via an isolated coupler, which may be an independent component or may be part of the drive unit 14A. The first drive motor 12A or the second drive motor 12B may generate a force and that force may be a rotational force. The force may be applied directly to the wheels 20 via the first drive motor 12A, indirectly, indirectly through the first gear box 14A, or through some combination. The force may be applied directly to the wheels 20 via the second drive motor 12A, indirectly, indirectly through the second gear box 14B, or through some combination.

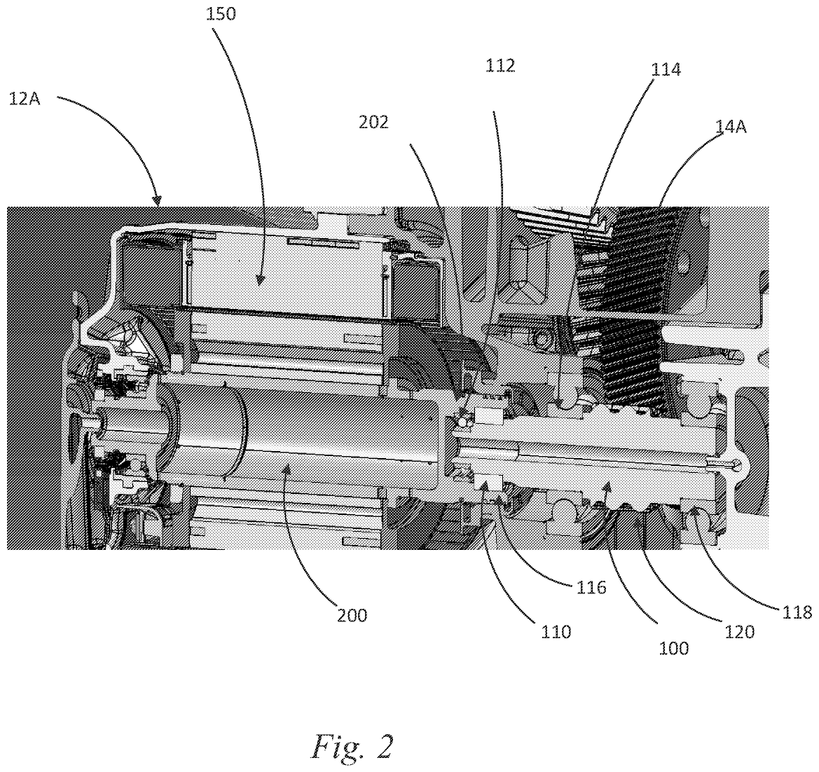

FIG. 2 illustrates a sectional view of an embodiment of a drive motor 12A, 12B and a gear box 14A, 14B. In the present embodiment the drive motor is an electric motor however the system may be another type of motor such as combustion. The drive motor 12A, 12B and the gear box 14A, 14B may be an integrated unit or they may be separate. In the present embodiment the drive motor 12A is coupled to the input gear 100 which is coupled to the gear box 14A. The drive motor 12A may comprise a stator 150 and a rotor 200. The rotor 200 may comprise a connector portion 202. The connector portion 202 in the present embodiment is located at one end of the rotor 200, however there may be a connector portion located at either end or both ends of the rotor. The connector portion 202 comprises grooves 204. The grooves 204 may be cylinder shaped as they are in the present embodiment. It should be appreciated that the grooves 204 may be other shapes such as square, rectangular, or spherical. Further, the grooves 204 may instead be a positive feature or any feature that allows for the engagement of the insulating elements 110.

The connector portion 202 of the rotor 200 is connected to the connector portion 104 of the input gear 100. The connection between the connector portion 202 and the connector portion 104 is made with the insulating elements 110. The insulating elements 110 engages both the rotor connector portion 202 and the input gear connector portion 104. The input gear connector portion 104 comprises a plurality of grooves 108. The grooves 108 may be cylindrical shaped or they may be rectangular, square, spherical, or any other shape that can engage the insulating elements 110. The shaped of the grooves 108 and the grooves 204 may be the same as the insulating elements 110 such that the insulating element 310 fits within the groove 108 and the groove 204. The input gear 100 may comprise a first bearing interface 116, a second bearing interface 118, and a gear portion 120. The gear portion 120 of the input gear 100 may engage with the vehicle rotor or the gear box 14A. The gear portion 120 in present embodiment is a gear, however the gear portion 120 may be any type of connections that can transfer power from the input gear 100 to the gear box 14A. The gearbox 14A may be any components that allows for a transfer of the power from the drive motor 14A to the wheels. In the present embodiment the drive motor 14A comprises a rotor interface 230.

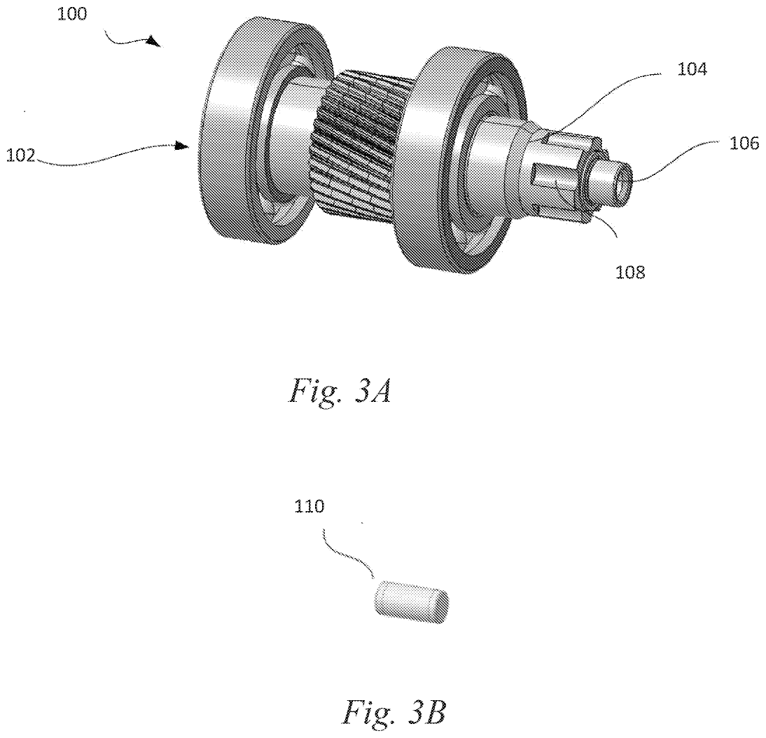

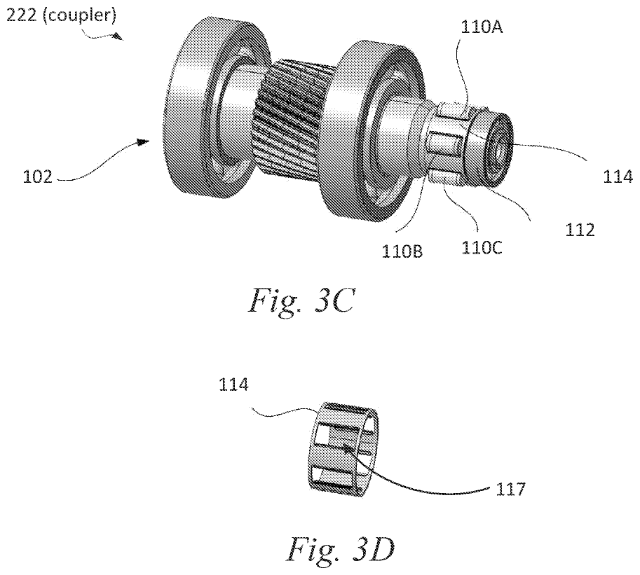

FIG. 3A illustrates a simplified block diagram of a perspective view of an input gear 100 with an isolated coupler formed in accordance with illustrative embodiments of the present application. As illustrated in FIG. 3A, the input gear 100 includes the rotor portion 102 that operates in conjunction with a rotor component within an electric motor. As described, the rotation of the rotor can in turn cause the input gear 100 to rotate via a physical connection between the rotor and the input gear 100, which in turn has an additional gear portion 120 for utilization in the operation of the electric motor, such as in an electric vehicle.

The input gear 100 can include a connector portion 104 that is perpendicular to the rotational axis 106 of the input gear 100. The connector portion 104 can be of various lengths based on a function of the torque experienced, materials utilized, and the like or the characteristics of the rotor component. Illustratively, in one embodiment, the connector portion 104 can include a plurality of cylindrical shaped grooves 108 for receiving one or more insulating elements 110 (illustrated in FIG. 3B). The grooves 108 of the connector portion 104 may be produced via manufacturing processes, including machining, grinding or other similar techniques. Although the grooves 108 are illustrated as having a cylindrical shape for receiving insulating elements of the same, or similar shape, in other embodiments, the grooves 108 may have a different shape properties. Additionally, in some embodiments, the grooves 108 may incorporate insulating elements 110 that may not have a uniform shape (e.g., a first portion of insulating elements having a first shape and a second portion of insulating elements have a second, different shape).

The insulating elements 110, which are illustrated in FIG. 3B, may be generally considered roller bearings The insulating elements 110 can be constructed of one of a variety of materials, such as ceramic, plastics or various other non-conductive materials. The dimension of the insulating elements, such as the length and diameter, may be selected as a function of the torque, the number of insulating elements in the connector, and the like. The insulating elements 110 may have relatively smooth outer surfaces. Additionally, in some embodiments, the insulating elements may include notches, protrusions, chamfered edges, and the like to facilitate placement, mounting, or retention in the grooves 108 (FIG. 3A).

Turning to FIG. 3C, in one embodiment, a rotor portion 102 of the input gear 100 can illustratively include six insulating elements 110 (illustrated with 110A, 110B, 110C) that are spaced equidistantly about the axis of the input gear 100. In other embodiments, the connector portion 104 can include a different number of insulating elements 110. In other embodiments, the insulating elements 110 may be distributed about the connector portion 104 in a non-equidistant manner or be embodied in different shapes. The input gear 100 can also include a bearing or non-conductive spacer 112 for bearing axial loads presented to/by the input gear. The input gear 100 can also include a retainer 114 for facilitating and retention of the insulating elements 110 in the connector portion 104. The retainer 114 shown in FIG. 3D may be optional. As illustrated in FIG. 3D, the retainer can include a number of openings 117 that correspond to placement of the insulating elements 110. The openings 117 can be configured in a manner to interface with the illustrating elements 110 for retention of the insulating elements, including, but not limited to, pressure fitting against sides of the insulating elements, adhesion with portions of the insulating elements, interface with complimentary protrusions or gaps, and the like. The retainer 114 may be mounted to the input gear 100 be adhesion, tension, soldering, and any number of additional mounting mechanisms.

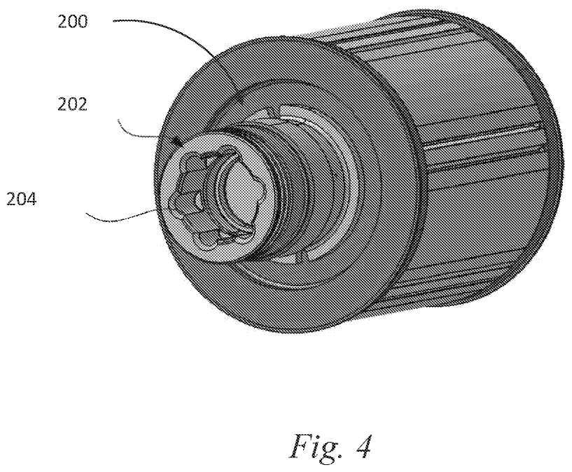

With reference to FIG. 4, the electric motor 12, comprising the rotor 200 for utilization in combination with the illustrative input gear 100 will be described. The electric motor 12A includes a group of electro-magnets arranged around a rotor 200, with the poles facing toward the stator poles. The rotor 200 is typically located inside the stator to cause a rotation of the rotor about an axis. Alternatively, the rotor 200 can be considered an outboard rotor. The electric motor 12A or the rotor 200 could include various materials, such as aluminum bars, steel laminations, magnets etc. to cause the induced current flow from a stator component or a magnetic field. As applied to the present application, the rotor 200 can include a connector portion 202, which is illustratively complimentary, at least in part, to the connector portion 104 of the input gear 100. More specifically, the connector portion 202 of the rotor 200 can include a set of grooves 204 that correspond directly the insulating elements 110 and the connector portion 104 of the input gear 100. The rotor 200 can be illustratively engaged to the input gear 100 based on the engagement of the insulating elements 110 with both the rotor and input gear. However, the rotor 200 and input gear 100 remain electrically isolated due to the non-conductive properties of the selected insulating elements 110. As described above, the groves 204 may be manufactured by various manufacturing processes, including but not limited to machining, grinding or other similar techniques.

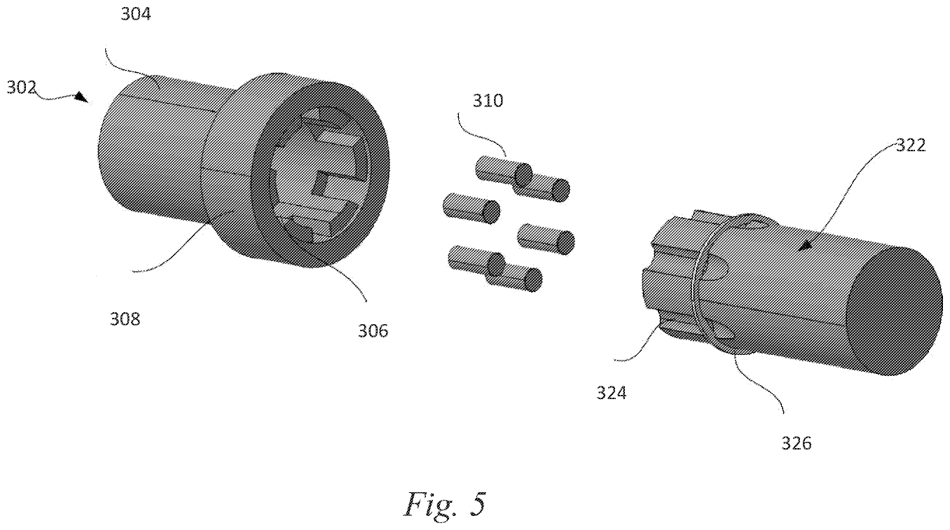

FIG. 5 corresponds to an alternative embodiment of an input gear 302 and portion of a rotor 322. The input gear 302 includes a connector portion 304 extending into a set of cutouts 306. The cutouts 306 are generally of a shape to accept a plurality of cylindrical shaped insulating elements 310. The cutouts 306 may be formed by machining or grinding. The input gear 302 further includes an outer collar 308 to at least retain the insulating elements 310. Illustratively, the connector portion 304 can be precision ground on the outside diameter (to improve the runout of the coupler) when combined with 308 collar. Such techniques can include machining, grinding (e.g., spline griding or worm griding) and the like.

The complimentary rotor 322 further includes a plurality of grooves 324 for receiving the insulating elements 310. The grooves 324 can be manufactured using techniques can such as machining, grinding (e.g., spline griding or worm griding) and the like. The rotor 322 can further include a snap ring 326 or shoulder for axial loads on the insulating elements. The insulating elements 110 can be constructed of one of a variety of materials, such as ceramic, plastics or various other non-conductive materials. The dimension of the insulating elements, such as the length and diameter, may be selected as a function of the torque, the number of insulating elements in the connector, and the like. As illustrated in FIG. 5, in one embodiment, six insulating elements 310 are spaced equidistantly about the axis of the input gear 302 and rotor 322. In other embodiments, the insulating elements 310 may be distributed about the connector portion 304 in a non-equidistant manner or be embodied in different shapes. Additionally, the number of insulating elements 310 may vary.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed air vent assembly. It is to be understood that the forms of disclosure herein shown and described are to be taken as representative embodiments. Equivalent elements, materials, processes, or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application

What is claimed:

1. An electric isolation coupler, the electric isolation coupler comprising:
an input gear, the input gear comprising an input gear connector portion;
a rotor, the rotor comprising a rotor connector portion; and
a plurality of insulating elements positioned between the input gear connector portion and the rotor connector portion, wherein the plurality of insulating elements are configured to connect the input gear connection portion to the rotor connector portion;
wherein the input gear and the rotor are electronically isolated.

2. The electric isolation coupler of claim 1, wherein the input gear connector portion comprises a plurality of input gear grooves, wherein the plurality of input gear grooves are configured to hold the plurality of insulating elements.

3. The electric isolation coupler of claim 2, wherein the rotor connector portion comprises a plurality of rotor grooves, wherein the plurality of rotor grooves correspond to the plurality of insulating elements for receiving the plurality of insulating elements.

4. The electric isolation coupler of claim 1, wherein each of the plurality of insulating elements is cylindrical shaped.

5. The electric isolation coupler of claim 1 further comprising a retainer attached to the input gear connecting portion, wherein the retainer is configured to retain the plurality of insulating elements to the input gear connector portion.

6. The electric isolation coupler of claim 1, further comprising a non-conductive spacer attached to the input gear connector portion, wherein the non-conductive spacer is attached between the plurality of the insulating elements and an end of the input gear connector portion and is configured for bearing axial load presented to and/or by the coupler.

7. The electric isolation coupler of claim 1, wherein at least one of the input gear connector portion or the rotor connector portion encompasses the other.

8. The electric isolation coupler of claim 1, wherein the rotor further comprises a stopping element, wherein the stopping element is configured to bear an axial load on the plurality of insulating elements.

9. The electric isolation coupler of claim 1, wherein the plurality of insulating elements are spaced equidistantly about an axis of the coupler.

10. An electric isolation system, the electric isolation system comprising:
a first component, the first component comprising a first component connector portion;
a second component, the second component comprising a second component connector portion; and
a plurality of insulating elements, wherein the plurality of insulating components create a connection between the first component connector portion and the second component connector portion;
wherein connection is an electrically isolated connection.

11. The electric isolation system of claim 10, wherein the first component connector portion comprises a plurality of first grooves, wherein the plurality of first grooves are configured to hold the plurality of insulating elements.

12. The electric isolation system of claim 11, wherein the second component connector portion comprises a plurality of second grooves, wherein at least one of an individual first groove of the plurality of first grooves corresponds to an individual second groove of the plurality of second grooves and wherein the corresponding at least one individual first groove and individual second groove are configured to hold an individual insulating element of the plurality of insulating elements.

13. The electric isolation system of claim 10, wherein the first component connector portion comprises a first axis, wherein the second component connector portion comprises a second axis and wherein the first axis is substantially similar to the second axis.

14. The electric isolation system of claim 13, wherein the connection is configured to allow a movement of the first component along the first axis and the second component along the second axis.

15. The electric isolation system of claim 10, wherein first component connector portion at least partially encloses the second component connector portion.

16. The electric isolation system of claim 10, wherein connection is configured to transfer rotational force between the first component connector portion and the second component connector portion.

17. An electric isolation system, the electric isolation system comprising:
an input gear, the input gear comprising an input gear connector portion;
a rotor, the rotor comprising a rotor connector portion; and
a plurality of equidistant, cylindrical shaped insulating elements positioned between the input gear connector portion and the rotor connector portion, wherein the plurality of insulating elements are configured to connect the input gear connection portion to the rotor connector portion;
wherein the input gear and the rotor are electronically isolated.

18. The electric isolation system of claim 17 wherein the plurality of insulating elements are made of at least one of a plastic or ceramic material.

19. The electric isolation system of claim 17 wherein the plurality of insulating elements are located about an axis in reference to the first component.

20. The electric isolation system of claim 17 further comprising an electric motor.
